(19) United States
(12) Patent Application Publication
(10) Pub. No.: US 2013/0306774 A1
(43) Pub. Date: Nov. 21, 2013

(54) Rotary cutting die for making pattern paper strips for a paper shredder

(71) Applicant: Kun Yuan Tong, Suwanee, GA (US)

(72) Inventor: Kun Yuan Tong, Suwanee, GA (US)

(21) Appl. No.: 13/506,835

(22) Filed: May 18, 2012

(51) Int. Cl. B02C 17/20

(52) U.S. Cl. 241/282.1

(57) ABSTRACT

The rotary cutting die of a paper shredder for making pattern paper strips has built-in trapezoid pattern or rectangular pattern cutting blades. It can cut a piece of paper into trapezoid or rectangular paper strips. These trapezoid and rectangular paper strips can be folded to make double-wing pouches to be articulated each other to make toys.

### THE BACKGROUND OF THE INVENTION

Ordinary paper shredders are designed to shred paper to destroy documents. The presented invented rotary cutting die for making pattern paper strips for a paper shredder is designed to produce pattern paper strips, such as trapezoid paper strips or rectangular paper strips, to be folded to be a double-wing pouch to articulate with each other to make toys.

### THE BRIEF SUMMERY OF THE INVENTION

Paper shredder with a pattern rotary cutting die can produce pattern paper strips, such as trapezoid paper strips or rectangular paper strips, to be folded to be double-wing pouches which can be articulated with each other to make toys.

### THE DETAILED DESCRIPTION OF THE DRAWINGS

FIG. 1 is the perspective view of a rotary cutting die which has built-in trapezoid patterned cutter for a paper shredder.

FIG. 2 is the flat view of the pattern of the built-in trapezoid pattern cutter of FIG. 1.

FIG. 3 is the flat view of a trapezoid paper strip of FIG. 2.

FIG. 4 is the flat view of a double-wing pouch which is converted from a trapezoid paper strip by folding sequentially according to the sequent number of dotted lines of FIG. 3.

FIG. 5 is the perspective view of a double-wing pouch after folding the central dotted line of FIG. 4.

FIG. 6 is the perspective view of a rotary cutting die which has built-in trapezoid pattern cutter for a paper shredder.

FIG. 7 is the flat view of the pattern of the built-in trapezoid pattern cutter of FIG. 6.

FIG. 8 is the flat view of a trapezoid paper.

FIG. 9 is a flat view of a double-wing pouch which is converted from the trapezoid paper strip by folding sequentially according to the sequent number of dotted lines of FIG. 8.

FIG. 10 is the perspective view of the rotary die which has built-in rectangular pattern cutter for a paper shredder.

FIG. 11 is the flat view of the pattern of built-in rectangular paper cutter of FIG. 10.

FIG. 12 is the flat view of a rectangular paper strip.

FIG. 13 is a flat view of a double-wing pouch which is converted from the rectangular paper strip by folding it sequentially according to the sequent number of dotted lines of FIG. 12.

### THE DETAILED DESCRIPTION OF THE INVENTION

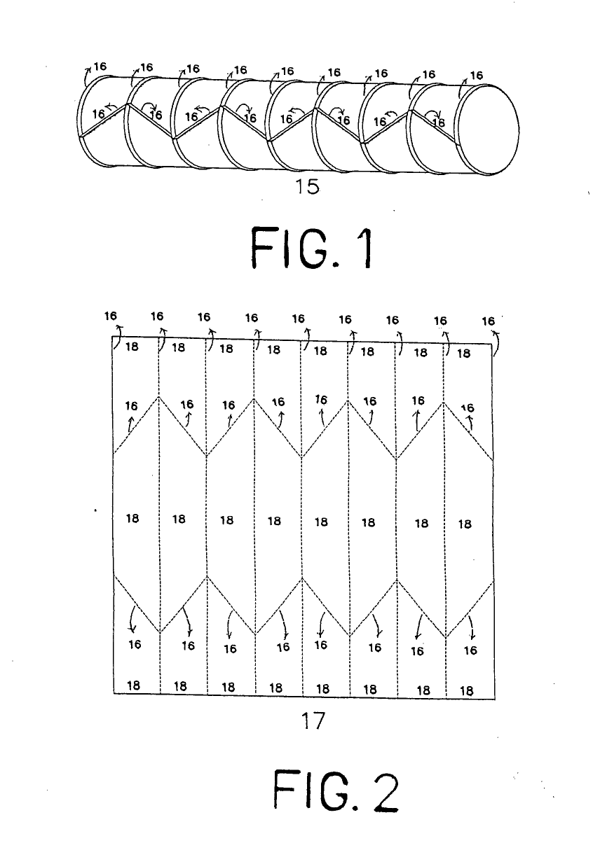

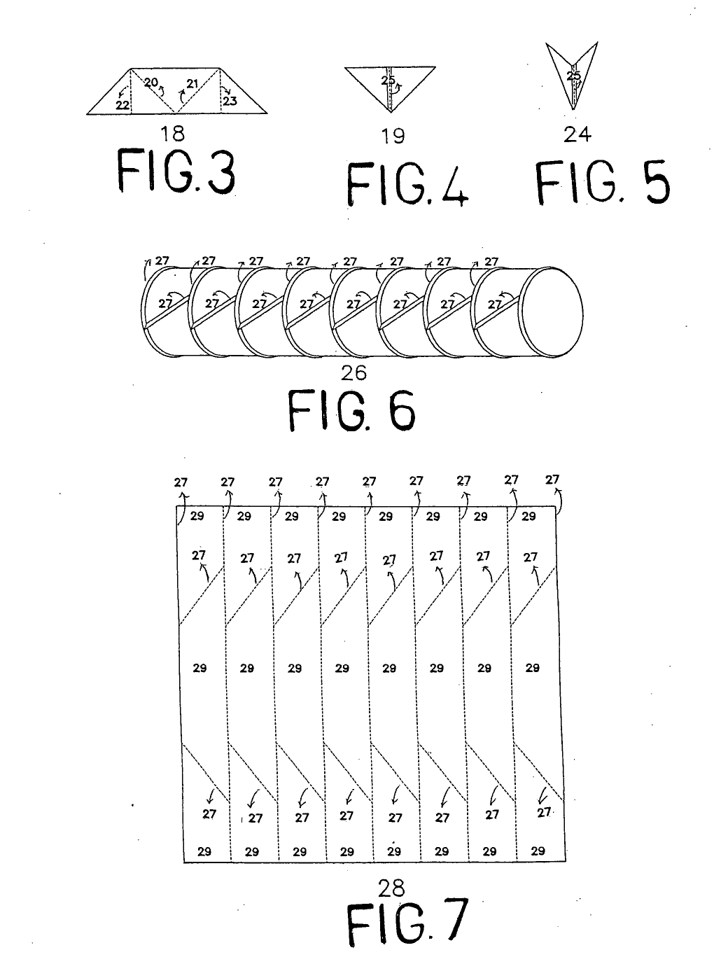

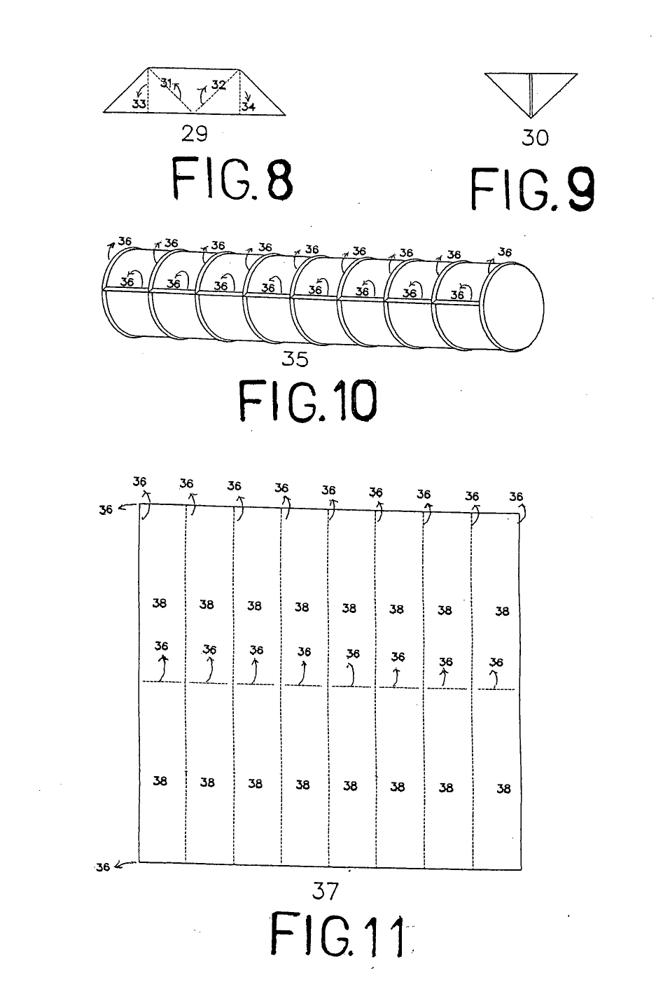

Referring now in detail to the drawings numeral 15 of FIG. 1 is the rotary cutting die which has built-in invert trapezoid cutter for producing trapezoid paper strips. Numeral 16 of FIG. 1 and FIG. 2 is cutting blade. Numeral 17 of FIG. 2 is the flat plane of pattern of invert trapezoid pattern cutter of FIG. 1. Numeral 18 of FIG. 2 and FIG. 3 is trapezoid paper strip which has two legs of equal length, one base with the length of two times of that of altitude and one base with the length of four times of that of altitude. Numeral 19 of FIG. 4 is bird's eye view of a double-wing pouch which is converted from trapezoid paper strip 18 by folding sequentially at dotted lines according to the sequent number 20, 21, 22 and 23 of FIG. 3. Numeral 24 of FIG. 5 is the perspective view of double-wing pouch 19 which is folded at the middle dotted line 25 of FIG. 4 and FIG. 5. Numeral 26 of FIG. 6 is a rotary cutting die which has built-in parallel trapezoid cutter for producing trapezoid paper strips. Numeral 27 of FIG. 6 and FIG. 7 is cutting blade. Numeral 28 of FIG. 7 is the flat plane of pattern of parallel trapezoid pattern cutter of FIG. 5. Numeral 29 of FIG. 7 and FIG. 8 is trapezoid paper strip which has two legs of equal length, one base with length of two times of that of altitude and one base with the length of that of four times of altitude. Numeral 30 of FIG. 9 is bird's eye view of a double-wing pouch which is converted from trapezoid paper strip 29 of FIG. 8 by folding sequentially according to the sequent number 31, 32, 33 and 34 of dotted lines of FIG. 8. Numeral 35 of FIG. 10 is the rotary cutting die which has built-in rectangular pattern cutter. Numeral 36 of FIG. 10 and FOG. 11 is cutting blade.

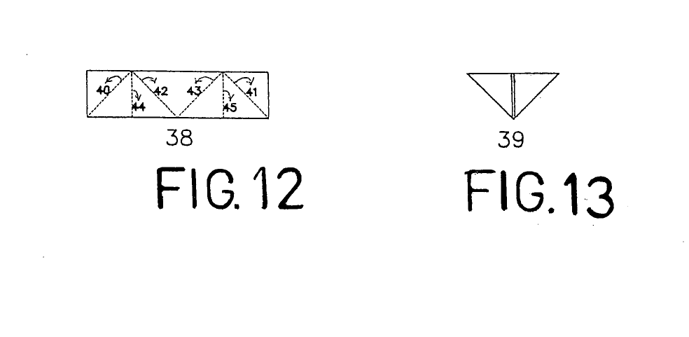

Numeral 37 of FIG. 11 is the pattern of the rectangular cutter of FIG. 10. Numeral 38 of FIGS. 11 and 12 is rectangular paper strip which has length four times of width. Numeral 39 of FIG. 13 is bird's eye view of a double-wing pouch which converted from a rectangular paper strip 38 of FIG. 12 by folding sequentially according to the sequent number 40, 41, 42, 43, 44 and 45 of dotted lines of FIG. 12.

1. Rotary cutting die of paper shredder for making pattern paper strips comprising a rotary trunk which has built-in cutting blades.

2. The said built-in cutting blades of claim 1 comprising trapezoid pattern cutting blade.

3. The said right trapezoid pattern of claim 2 consisting of two legs of equal length, one base with the length of two times of height and one base of four times of height.

4. The said built-in cutting blades of claim 1 comprising rectangular pattern cutting blade.

5. The said rectangular pattern of claim 4 consisting of two equal widths and two equal lengths wherein said length is two times longer than said width.
